(19) United States
(12) Patent Application Publication
(10) Pub. No.: US 2014/0232654 A1
(43) Pub. Date: Aug. 21, 2014

(54) MOUSE WHEEL DEVICE

(71) Applicant: CHENG UEI PRECISION INDUSTRY CO., LTD., New Taipei City (TW)

(72) Inventors: Tsung Shih LEE, New Taipei City (TW); Yu Hsiang TING, New Taipei City (TW)

(73) Assignee: CHENG UEI PRECISION INDUSTRY CO., LTD., New Taipei City (TW)

(21) Appl. No.: 13/773,598

(22) Filed: Feb. 21, 2013

(51) Int. Cl. G06F 3/0354

(52) U.S. Cl. CPC G06F 3/03543
USPC 345/163

(57) ABSTRACT

A mouse wheel device includes a mouse wheel assembly including at least two scroll wheels, at least two wheel shafts and a track, and a mounting bracket. Each scroll wheel has a through hole axially penetrating through a center thereof. The outer side surface of the scroll wheel defines a plurality of meshing grooves. Each of the scroll wheels is axially mounted to the middle of one of the wheel shafts via the through hole. The track is sheathed on the outer side surfaces of the scroll wheels with the scroll wheels being apart arranged side-by-side. The inner surface of the track protrudes inward to form a plurality of meshing ribs engaged with the meshing grooves to drive the scroll wheels and the wheel shafts to rotate in the same direction. The mouse wheel assembly is pivoted to the mounting bracket through two ends of each wheel shaft.

### BACKGROUND OF THE INVENTION

1. Field of the Invention

The present invention relates to a mouse technology field, and more particularly to a mouse wheel device assembled in a mouse.

2. The Related Art

Referring to FIG. 1, a conventional mouse wheel device 10′ is shown. The mouse wheel device 10′ is assembled in a mouse 1′ and includes a scroll wheel 11′, a wheel shaft 12′ and a mounting bracket 13′. The scroll wheel 11′ is rotatably mounted to the mounting bracket 13′ by the wheel shaft 12′. In use, some functions of a computer can be controlled by the mouse 1′ via scrolling the scroll wheel 11′.

Referring to FIG. 2, in order to make the mouse 1′ easy to use for users, the scroll wheel 11′ of the mouse 1′ is designed with a larger size so as to have a longer length L′ of the exposed part, so that can provide a larger touch area for the convenience of the users using the mouse 1′. But it relatively causes the mouse 1′ have a thicker thickness H′.

With the development of electronic technology and the needs for fashion, a kind of light and thin mouse has come in the market largely. Referring to FIG. 3, it shows another mouse 1″ with a thinner thickness H″. Accordingly, the mouse 1″ has a smaller scroll wheel 11″ for meeting the requirement of the thinner thickness H″. But it relatively results in a shorter length L″ of the exposed part of the scroll wheel 11″. As a result, the touch area of the exposed part of the scroll wheel 11″ became smaller accordingly that causes a difficult use for the users.

Therefore, in order to meet the requirement of the thinner thickness H″ of the mouse 1″, it is necessary to provide a new mouse wheel device which has low height and large touch area, for the convenience of the users in use.

### SUMMARY OF THE INVENTION

An object of the present invention is to provide a mouse wheel device adapted for being assembled in a mouse. The mouse wheel device includes a mouse wheel assembly including at least two scroll wheels, at least two wheel shafts and a track, and a mounting bracket. Each of the scroll wheels has a through hole axially penetrating through a center thereof. The outer side surface of the scroll wheel defines a plurality of meshing grooves arranged at regular intervals along the periphery thereof. Each of the scroll wheels is axially mounted to the middle of one of the wheel shafts via the through hole. The track is sheathed on the outer side surfaces of the scroll wheels with the scroll wheels being apart arranged side-by-side. The inner surface of the track protrudes inward to form a plurality of meshing ribs arranged at regular intervals along the inner periphery thereof and engaged with the meshing grooves of the scroll wheels. The mouse wheel assembly is pivoted to the mounting bracket through two ends of each wheel shaft. One long side of the track along the arrangement direction of the scroll wheels is exposed outside the mouse. When the exposed long side of the track is actuated, the track drives the scroll wheels and the wheel shafts to rotate in the same direction.

As described above, the mouse wheel device of the present invention utilizes at least two scroll wheels and the track sheathed on the outer side surfaces of the scroll wheels with the scroll wheels being apart arranged side-by-side, instead of one large scroll wheel or only one small scroll wheel in the prior art, so that makes the mouse wheel device have a longer length for realizing a large touch area of the exposed long side thereof and a low height for meeting the requirement of a thinner thickness of the mouse.

### BRIEF DESCRIPTION OF THE DRAWINGS

The present invention will be apparent to those skilled in the art by reading the following description thereof, with reference to the attached drawings, in which:

FIG. 1 is an assembled perspective view of a conventional mouse wheel device assembled in a mouse with a thicker thickness;

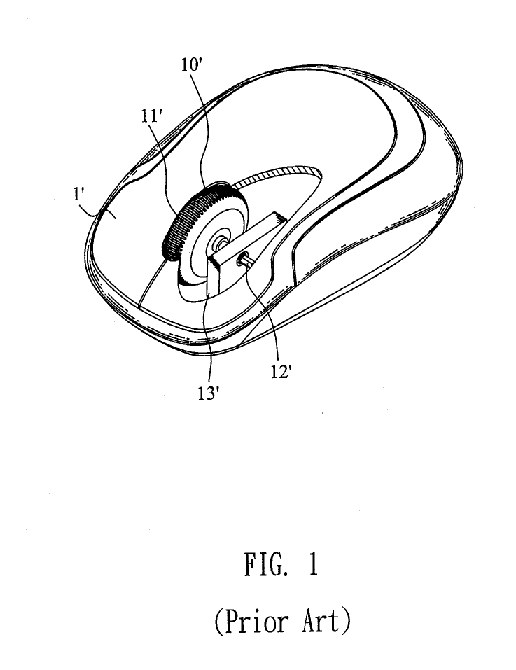

FIG. 2 is a lateral view of the mouse with the mouse wheel device of FIG. 1;

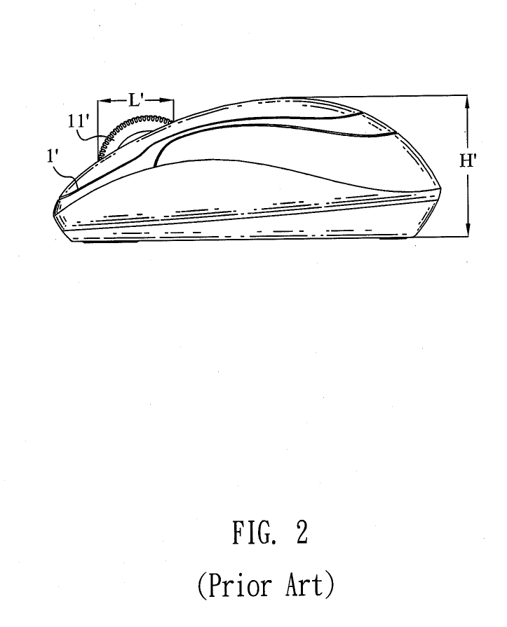

FIG. 3 is a lateral view showing that another conventional mouse wheel device is assembled in another mouse with a thinner thickness;

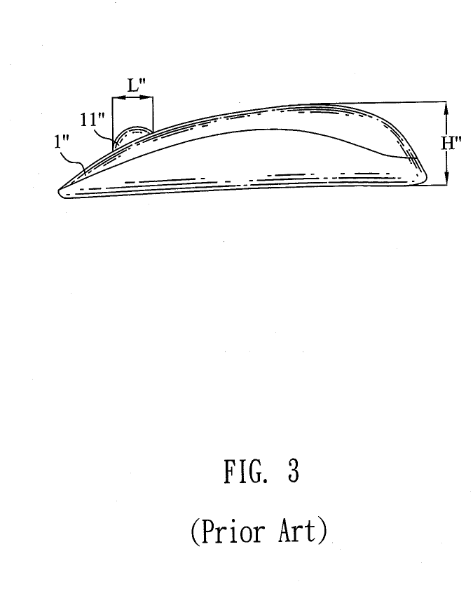

FIG. 4 is an assembled perspective view of a mouse wheel device according to an embodiment of the present invention;

FIG. 5 is a perspective view of a scroll wheel of the mouse wheel device of FIG. 4;

FIG. 6 is a perspective view of a track of the mouse wheel device of FIG. 4; and

FIG. 7 is a lateral view showing that the mouse wheel device of FIG. 4 is assembled in a mouse with a thinner thickness.

### DETAILED DESCRIPTION OF THE EMBODIMENT

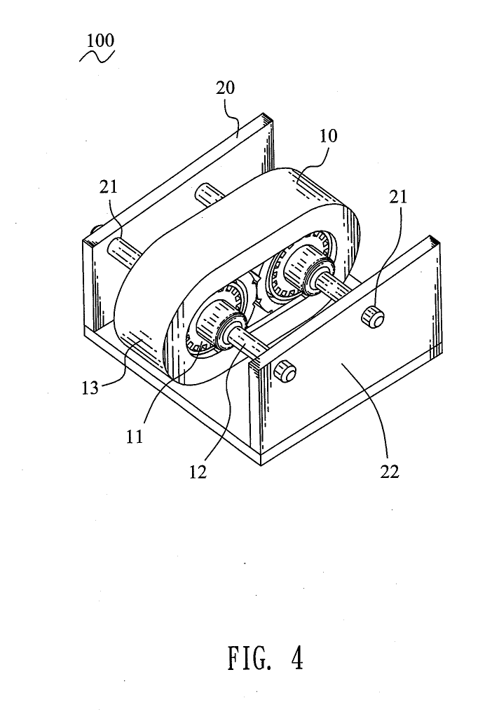

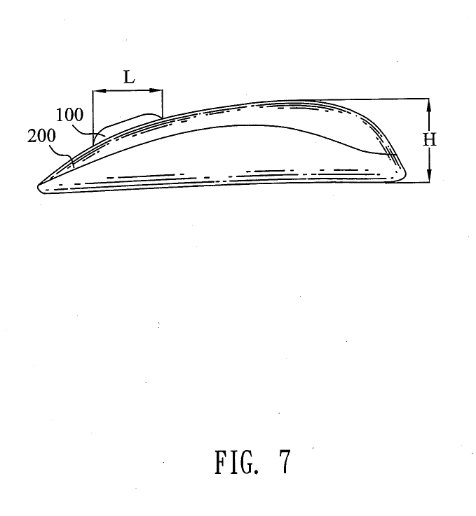

Referring to FIG. 4 and FIG. 7, a mouse wheel device 100 according to an embodiment of the present invention is assembled in a mouse 200 with a thinner thickness H. The mouse wheel device 100 includes a mouse wheel assembly 10 and a mounting bracket 20, wherein the mouse wheel assembly 10 is pivoted to the mounting bracket 20.

Referring to FIGS. 4-7, the mouse wheel assembly 10 includes at least two scroll wheels 11, at least two wheel shafts 12 and a track 13. Each of the scroll wheels 11 has a through hole 111 axially penetrating through a center thereof. The outer side surface of the scroll wheel 11 defines a plurality of meshing grooves 112 arranged at regular intervals along the periphery thereof. Each of the scroll wheels 11 is axially mounted to the middle of one of the wheel shafts 12 via the through hole 111.

The track 13 is sheathed on the outer side surfaces of the scroll wheels 11 with the scroll wheels 11 being apart arranged side-by-side. The inner surface of the track 13 protrudes inward to form a plurality of meshing ribs 131 arranged at regular intervals along the inner periphery thereof and engaged with the meshing grooves 112 of the scroll wheels 11.

Then the mouse wheel assembly 10 is pivoted to the mounting bracket 20 through two ends of each wheel shaft 12. Lastly, the mouse wheel device 100 is assembled in the mouse 200 with the thinner thickness H with one long side of the track 13 along the arrangement direction of the scroll wheels 11 being exposed outside the mouse 200. In detail, the length L of the exposed long side of the track 13, namely the touch area with the fingers of users, depends on the interval between each two adjacent scroll wheels 11 and the diameter of each scroll wheel 11. In this embodiment, the scroll wheel 11 has a smaller diameter (namely a low height) for meeting the requirement of the thinner thickness H of the mouse 200, and the scroll wheels 11 have at least two for realizing a longer length L (namely a large touch area) of the exposed long side of the track 13.

In use, when the exposed long side of the track 13 is actuated by the fingers of the users, the track 13 drives the scroll wheels 11 and the wheel shafts 12 to rotate in the same direction by virtue of the meshing ribs 131 being engaged with the meshing grooves 112 of the scroll wheels 11.

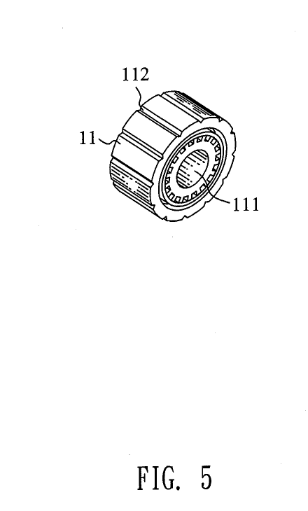

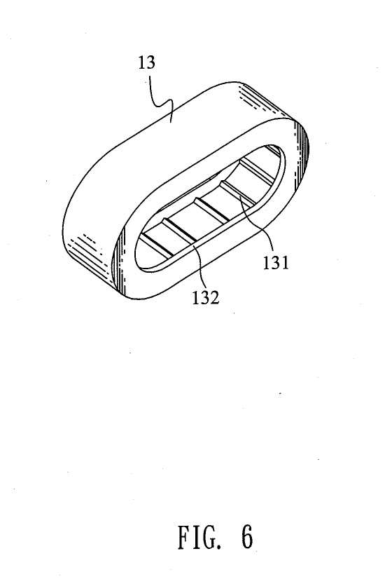

Referring to FIG. 5 and FIG. 6, in this embodiment, each of the meshing grooves 112 of the scroll wheel 11 extends along the generatrix of the scroll wheel 11, and each meshing rib 131 of the track 13 extends in accordance with the meshing groove 112 for being engaged in the meshing groove 112 to drive the scroll wheel 11 to rotate.

Referring to FIG. 4 and FIG. 6, two side edges of the track 13 extends inward to form a pair of ring-shaped restraining brims 132 blocking at two opposite end faces of the scroll wheels 11 and restraining the scroll wheels 11 therebetween so as to prevent the track 13 from moving and coming off from the scroll wheels 11. In this embodiment, the track 13 has the inner surface thereof made of hard rubber and the outer surface thereof made of soft rubber.

Referring to FIG. 4 again, the mounting bracket 20 is substantially U-shaped and two face-to-face plates 22 thereof define at least two pairs of pivoting holes 21. Each pair of the pivoting holes 21 is used to pivot the two ends of one wheel shaft 12 therein so as to apart locate the scroll wheels 11 and the track 13 between the face-to-face plates 22 of the mounting bracket 20.

As described above, the mouse wheel device 100 of the present invention utilizes at least two scroll wheels 11 and the track 13 sheathed on the outer side surfaces of the scroll wheels 11 with the scroll wheels 11 being apart arranged side-by-side, instead of one large scroll wheel 11′ or only one small scroll wheel 11″ in the prior art, so that makes the mouse wheel device 100 have the longer length L for realizing the large touch area of the exposed long side thereof and the low height for meeting the requirement of the thinner thickness H of the mouse 200.

What is claimed is:

1. A mouse wheel device adapted for being assembled in a mouse, comprising:
a mouse wheel assembly including
at least two scroll wheels, each of the scroll wheels having a through hole axially penetrating through a center thereof, the outer side surface of the scroll wheel defining a plurality of meshing grooves arranged at regular intervals along the periphery thereof,
at least two wheel shafts, each scroll wheel being axially mounted to the middle of one of the wheel shafts via the through hole, and
a track sheathed on the outer side surfaces of the scroll wheels with the scroll wheels being apart arranged side-by-side, the inner surface of the track protruding inward to form a plurality of meshing ribs arranged at regular intervals along the inner periphery thereof and engaged with the meshing grooves of the scroll wheels; and
a mounting bracket, the mouse wheel assembly being pivoted to the mounting bracket through two ends of each wheel shaft,
wherein one long side of the track along the arrangement direction of the scroll wheels is exposed outside the mouse, when the exposed long side of the track is actuated, the track drives the scroll wheels and the wheel shafts to rotate in the same direction.

2. The mouse wheel device as claimed in claim 1, wherein each of the meshing grooves of the scroll wheel extends along the generatrix of the scroll wheel, and each meshing rib of the track extends in accordance with the meshing groove for being engaged in the meshing groove to drive the scroll wheel to rotate.

3. The mouse wheel device as claimed in claim 1, wherein two side edges of the track extends inward to form a pair of ring-shaped restraining brims blocking at two opposite end faces of the scroll wheels and restraining the scroll wheels therebetween.

4. The mouse wheel device as claimed in claim 1, wherein the mounting bracket is substantially U-shaped and two face-to-face plates thereof define at least two pairs of pivoting holes, each pair of the pivoting holes is used to pivot the two ends of one wheel shaft therein to apart locate the scroll wheels and the track between the face-to-face plates of the mounting bracket.

5. The mouse wheel device as claimed in claim 1, wherein the track has the inner surface thereof made of hard rubber and the outer surface thereof made of soft rubber.
